(19) United States
(12) Patent Application Publication
(10) Pub. No.: US 2005/0081189 A1
(43) Pub. Date: Apr. 14, 2005

(54) Aggregation of document elements into runtime code

(76) Inventors: Sophia Krasikov, Katonah, NY (US); Robert L. Hoch, Wilton, CT (US); John F. Morar, Mahopac, NY (US); Senthil Velayudham, Thornwood, NY (US)

Correspondence Address: Ido Tuchman, Suite 503, 69-60 108th Street, Forest Hills, NY, 11375, US

(21) Appl. No.: 10/684,552

(22) Filed: Oct. 14, 2003

(51) Int. Cl. G06F 9/44

(52) U.S. Cl. 717/123

(57) ABSTRACT

A method, system, and computer program for creating a minimum executable unit. Generating the minimum executable unit includes receiving at least one block of source code and at least one document element associated with the source code, validating consistency between the source code and the document element, and building an executable unit responsive to both the source code and the document element. In one embodiment the document elements utilize tag-based syntax to demarcate information, such as target audience and document granularity.

### FIELD OF THE INVENTION

The present invention relates combining program code with documentation and, more specifically, synchronizing the source code with document elements.

### BACKGROUND

Software documentation is a key component in the construction of any software product. Documentation serves a variety of purposes. Systems analysts and designers use documentation to communicate system requirements and design to users, management, and the implementation team during the development process. Developer documents can describe external interfaces for a software package as well as the algorithms, methods and techniques that the programmers have used to create the software. Installation documentation may include deployment information that describes the performance characteristics of an application in a certain hardware environment.

Good documentation enhances market perception of a software product and of the company producing the software. Supplying adequate documentation also reduces product support costs. In addition, easily accessible and adequate documentation helps software users do their jobs faster and more efficiently.

In the case of commercial software products, a desire to satisfy customers and to hold down support costs creates pressure to keep adequate software documentation. On the other hand, custom software, whether purchased or developed in-house, frequently leads to cases of inadequate or out of date documentation. The field of legacy application support typically grows increasingly difficult in cases where major system components lack adequate documentation and where support relies on informal networks of individual expertise. As a result, there have been attempts to address documentation needs through layers of process and project management.

One known technique for managing and aggregating documentation is to utilize Software Configuration Management (SCM) systems. SCM systems have been used extensively in the software development community as a way to manage documents and source code during all aspects of the software development process. SCM systems are often used to manage the software life cycle. Some SCM systems currently in use are CMVC, CVS (http://www.cvshome.com), and Rational ClearCase (http://www.rational.com).

Another technique for managing and aggregating documentation is to utilize Content Management (CM) systems. CM systems are used to store specifications, reference manuals, test programs, and other development software artifacts and to determine the details of software functionality. A CM system provides authoring tools, a repository for storing, versioning, managing workflow, and publishing documentation. Authors can also use check-in and check-out CM system capabilities to prevent overwrite when multiple authors are involved in changing a document at the same time.

There have also been several attempts to synchronize source code with documentation (also known as the “source” paradigm). For example, document generating programs (DGP), such as JavaDoc and DOC++, create hierarchical, cross-linked, browseable HTML documents of class libraries and APIs. The comments in the source code serve as input for DGP, and they are kept only in the source code. The documentation generated is generally only intended for interface description and are not well suited for generating printed documentation for the entire software module or package.

Another approach to synchronize source code with documentation is referred to as “enriched software code”, such as described in http://www.csu.edu.au/special/conference/apwww95/papers95/avogel/avogel .html. In this approach, HTML documentation is placed in an include file of a source code. The software documentation is typically embedded in an overall project management document hierarchy.

“Literate programming systems”, such as described in http://literateprogramming.com, have an approach in which instead of writing code containing documentation, the literate programmer writes the documentation containing code. A special compiler is used to separate the code from the documentation and to compile the code into object code. The resulting object code does not include the documentation.

In general, none of the methods discussed above can pass a consistency check between documentation and the associated software deployment package if a consistency check were performed. For example, the generated documentation may be packaged as part of a software deployment package; however, the consistency of JavaDoc elements in the deployment package cannot be checked against the changes made in the JavaDoc source. Similarly, documentation such as comments in source code or to an include file included in a software deployment package cannot be validated for consistency when changed.

In UNIX(r) operating systems, most of the shell commands use command line option “-h” that provide a minimal documentation to the user. This documentation is part of the binary code, but (1) it is limited (2) it cannot be independently extracted (3) there is no way to validate the consistency of the documentation with the software deployment package. UNIX is a registered trademark of Unixsystem Laboratories, Inc.

Compressed data packages, such as zip files, may include executables and associated documentation accompanying the software deployment package. However, such documentation can be only validated for consistency at the component level, and not across all the components.

### SUMMERY OF THE INVENTION

The present invention addresses the above-mentioned limitations of conventional documentation systems by generating a minimum executable unit (MEU) that is produced by embedding documentation for the purpose of synchronizing it with the code. The MEU provides a means for validating the consistency of the presence of the embedded documentation. In addition, the MEU provides a means for extracting and delivering the embedded documentation to a target in a readable/printable form.

Thus, one aspect of the invention is a method for creating a minimum executable unit. The method includes receiving operations to receive at least one block of source code and at least one document element associated with the source code. A validating operation validates the consistency between the source code and the document element. A building operation creates an executable unit which is responsive to both the source code and the document element.

Another aspect of the invention is program code embodied on computer-readable media. The program code includes at least one block of source code providing executable computer instructions and at least one documentation string coupled to the source code. The documentation string includes a method indicia configured to identify the method where the documentation string is located, a target indicia configured to identify who the documentation string is targeted to, and a granularity indicia configured to identify the what document documentation string should be a part of.

A further aspect of the invention is a system for creating a minimum executable unit. The system includes at least one block of source code and at least one document element associated with the source code. A validation criteria is configured to validate the consistency between the source code and the document element. A builder is configured to construct an executable unit responsive to both the source code and the document element.

Yet another aspect of the invention is a computer program product embodied in a tangible media. The computer program product includes program codes configured to cause the program to receive at least one block of source code and at least one document element associated with the source code, validate consistency between the source code and the document element, and build an executable unit configured to be responsive to both the source code and the document element.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows an exemplary network environment embodying the present invention.

FIG. 2 shows one embodiment of a documentation system contemplated by the present invention.

FIG. 3 shows an exemplary document element embodied in source code.

FIG. 4 shows an exemplary minimum executable unit development environment contemplated by the present invention.

FIG. 5 shows an exemplary flowchart for inserting document elements into the source code.

FIG. 6 shows an exemplary process for validating the consistency of the document elements.

FIG. 7 shows an exemplary execution environment employing the present invention.

### DETAILED DESCRIPTION OF THE INVENTION

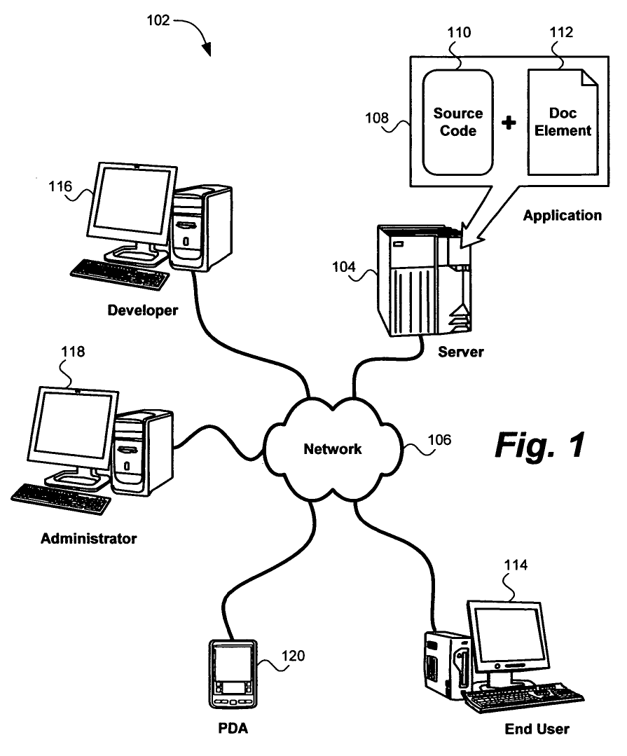

The following description details how the present invention is employed to provide program code with documentation such that the code and documentation are synchronized. Throughout the description of the invention reference is made to FIGS. 1-7. When referring to the figures, like structures and elements shown throughout are indicated with like reference numerals.

FIG. 1 shows an exemplary environment 102 embodying the present invention. It is initially noted that the environment 102 is presented for illustration purposes only, and is representative of countless configurations in which the invention may be implemented. Thus, the present invention should not be construed as limited to the environment configurations shown and discussed herein.

The environment 102 includes a server 104 coupled to a network 106. The network 106 may be any network known in the art for effectuation communications between the various devices in the environment 102. Thus, the network 106 can be a local area network (LAN), a wide area network (WAN), or a combination thereof. It is contemplated that the network 106 may be configured as a public network, such as the Internet, and/or a private network, and may include various topologies and protocols known in the art.

The server 104 includes at least one software application 108, such as a web service. The software application 108 may utilize service-oriented architecture, allowing clients to request service remotely using standard access mechanisms known in the art. According to one embodiment of the present invention, the software application 108 includes source code 110 and document elements 112 embedded into the source code 110. The embedded document elements 112 are used to build application documentation responsive to client requests. For example, an end user 114 of the application 108 may be presented with end user documentation, while an application developer 116 may be presented with developer documentation. An application administrator 118 may receive administration documentation that is different from both the end user and developer documentation.

As another example, the application 108 may present short application documentation tailored for a client with a low bandwidth connection and limited user interface, such a personal digital assistant (PDA) client 120. On the other hand, the application 108 may pass long application documentation to a desktop client 114 with a high bandwidth connection and full user interface.

As discussed in detail below, embedding document elements 112 into the source code 110 according to the present invention provides greater control and flexibility over application documentation. Smaller, targeted documentation can be tailored and delivered to various target audiences. The server 104 may validate the documentation to ensure consistency between the documentation and the application 108. Documentation detail can be adjusted from general to specific. Furthermore, documentation can be exported and imported to and from other applications using standard application interfaces.

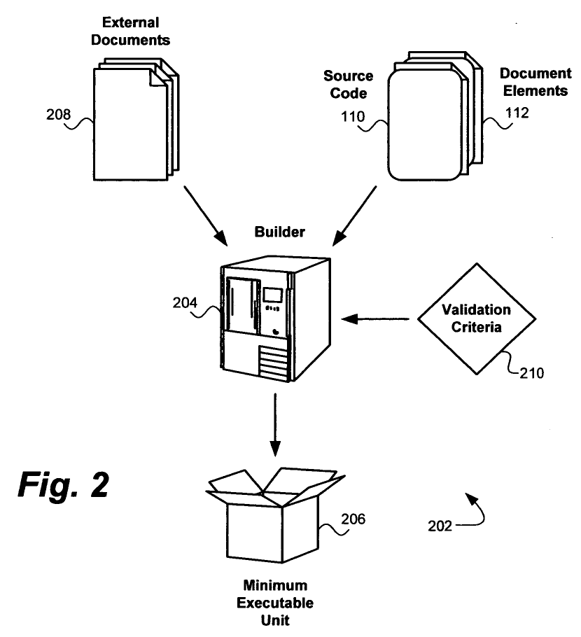

FIG. 2 shows one embodiment of a documentation system 202 contemplated by the present invention. The system 202 includes one or more document elements 112 embedded in source code 110. As used herein, a document element 112 is any basic unit of documentation that has at least minimal value for a software product. Document elements 112 may include complete or partial user manuals, architecture documentation, developer documentations, deployment and maintenance documentation, and help documentation. Various methods known in the art for embedding document elements 112 into source code 110 may be used with present invention. One method for embedding document elements 112 into source code 110 in accordance with the invention is described below.

A builder 204 combines the document elements 112 and source code 110 to create a minimum executable unit (MEU) 206. As used herein, an MEU 206 is a self-contained executable file comprising at least the minimum executable code and documentation for an application. The MEU 206, for example, may be embodied as an enterprise archive (EAR) file, a Microsoft installable (MSI) file, a cabinet (CAB) file, or a Web archive (WAR) file. The MEU format is an implementation choice dependent on the available operating system and resources at the target server receiving the MEU 206.

The builder 204 may also receive external documents 208 not embedded in the source code 110. Typically, the external documents 208 are preexisting document artifacts that are packaged as part of the MEU 206. The external documents 208 may include documents of various formats known in the art, such as text documents, word processor specific documents, portable document format (PDF) documents, and extensible markup language (XML) documents.

Along with creating the MEU 206, the builder 204 is configured to perform a consistency check between the source code 110 and the document elements 112. A validation criteria 210 received by the builder 204 specifies requirements that must be met by the document elements 112. For example, the validation criteria 210 may indicate the number of document elements, the number of chapters, and/or document element signatures that must be present in the MEU 206. Thus, the validation criteria 210 helps ensure that the document elements are not tampered with or excluded from the MEU build. In addition, the MEU 206 may be checksummed and configured not to operate if the checksum is violated, thereby preventing the removal or other modification of the document element(s) 112 within the MEU 206.

The documentation system 202 therefore enables placement of document elements 112 into the MEU 206 in two ways. Firstly, the document elements 112 are treated as source code 110. When the source code 110 is compiled and delivered to a user, the document elements 112 are delivered as part of the MEU 206. Secondly, external documents 208 may be included in the MEU 206 while building the MEU 206. The consistency checking based on selected validation criteria 210 may be performed immediately after the build as well as during run time. The extracted and aggregated document elements 112 always correspond to the MEU 206. One of the benefits of this approach is that when a user rolls back to the previous release of software, a roll back of the document elements 112 is not needed. The document elements extraction methods can be part of the delivered software API or may be implemented in the application user interface.

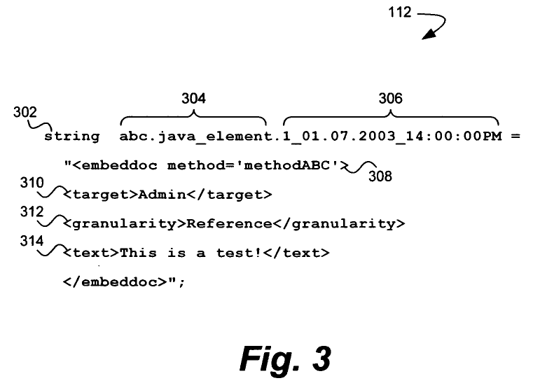

Turning now to FIG. 3, an exemplary document element 112 embodied in source code is shown. The document element 112 includes a string declaration 302 to reserve memory in computer readable media for the document element 112. The document element string can be uniquely identified by a value composed of such identifiers as file names 304, sequence numbers and/or time stamps 306.

In a particular embodiment of the invention, the document element 112 includes tag-based syntax to demarcate information within the string. For example, an embeddoc tag 308 may be used to specify the beginning of the document element string. The embeddoc tag 308 may also indicate the method associated with the document element 112. The method identification may be passed to an aggregating function that traverses the code and aggregates document element strings into one or more documents.

In addition, the string 302 may include a target tag 310 to indicate the target audience of the document element 112, a granularity tag 312 to indicate what document the document element 112 is part of, and a text tag 314 to indicate the text of the document element 112. The tag-based grammar inside a string may use XML-grammar-tag format. The string may also include any HTML tags, such as font, paragraph, table, etc. Table 1 describes some possible tags and possible tag entries. The string may further include a mapping component that creates an intelligent catalog of classes, functions, modules, or design artifacts passed to an aggregating function.

TABLE 1
Examples of possible tags and possible
tag entries for document element strings.

| Tag | Description | Values |
|---|---|---|
| <Embeddoc> | Specifies the beginning of a | |
| | string | |
| <Method> | Specifies the method where the | |
| | string is located | |
| <Target> | Target is who the string is | Administrator, |
| | targeted to | developer, |
| | | architect |
| <Granularity> | Granularity is what document | Operational |
| | this string should be part of | manual, API, |
| | | design document |

A tag based grammar such as kind introduced above, if standardized, can be used by any text editor to enrich an existing editor's features, such as insertion of comments and any electronic conversation such as e-mail or chat. Comments or other insertions can be later extracted and compiled as a review, critique, or opinion by the same editor or another tool.

It is contemplated that document elements may be encrypted only accessed with a decryption key. For example, document elements may be encrypted with multiple keys such that the document elements can be made available in a granular fashion. Furthermore, the keys may be arranged hierarchically such that all lower level keys are contained in the document element encrypted with a higher-level key. In this way, one key will provide a user with the ability to access the current document element and any of its lower level document elements.

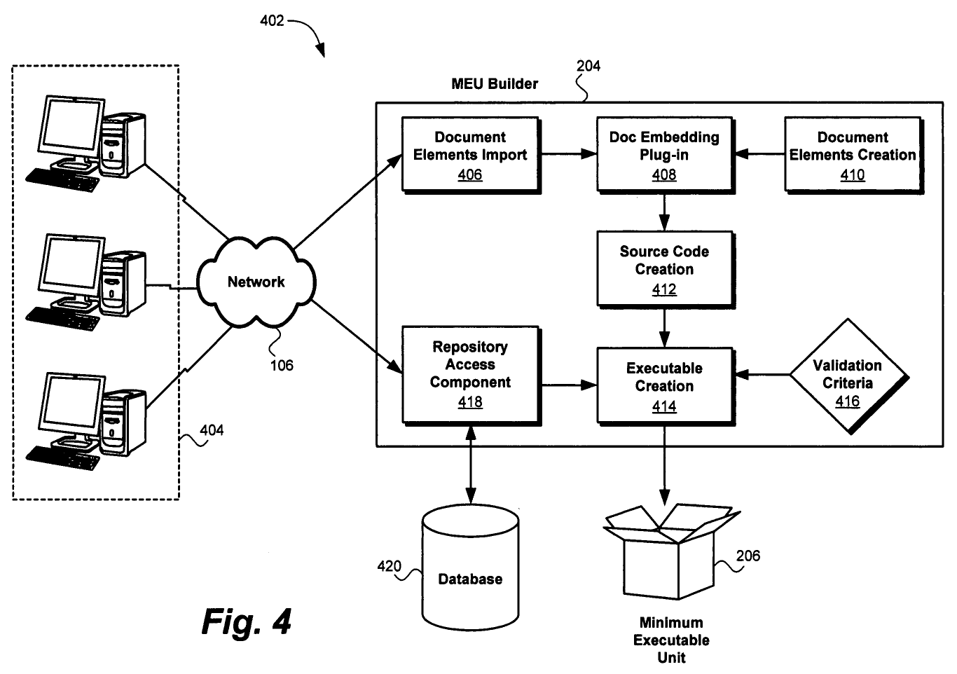

In FIG. 4, an exemplary MEU development environment 402 contemplated by the present invention is shown. The MEU builder 204 is coupled to several external document providers 404, such as developers, via the network 106. The external document providers 404 provide document elements to be added to the source code. In a particular embodiment of the invention, document elements may be added to the source code using a WYSWYG (what you see is what you get) text editor that understands the embedded document (“embeddoc”) tags.

The embeddoc editor may automatically create unique IDs for document element strings. The described common interface can be added to a source code editor that is part of an Integrated Development Environment.

Adding document elements with an embeddoc editor practically guarantees formal compatibility between document elements and the aggregating function. If document elements are composed without an editor, a special “validation and refinement” component may be included in some embodiments of the invention. Such a software component can validate compatibility and refine the document elements for further compatibility with the aggregating function.

The MEU builder 204 receives the external documents at a Document Element Import module 406. The Document Element Import module 406 is configured to pass the document elements to a Document Embedding Plug-in module 408, where the documents may be validated and refined. Developers may further create source code in a Source Code Creation module 412 and document elements in a Document Element Creation module 410.

The Document Embedding Plug-in module 408 is configured to insert the document elements from the external document providers 404 and the Document Elements Creation module 410 into the source code. Once the source code with embedded document elements is created, executable code is produced by an Executable Creation module 414. A Validation Criteria module 416 is used to check the consistency of the document elements. In addition, document owners may place documents into one or more databases 420 using a Repository Access Component module 418. The Repository Access Component module 418 may be called upon by the Executable Creation module 414 to access documentation stored in the databases 420. The final product of the build process is the MEU 206 discussed in detail above.

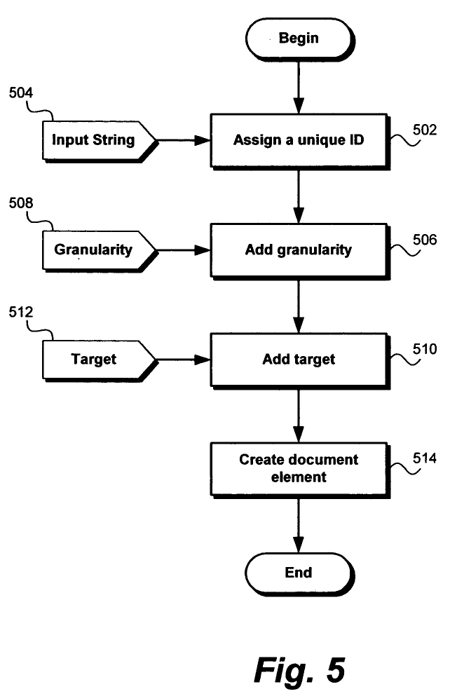

In FIG. 5, an exemplary flowchart for inserting document elements into the source code is shown. It should be remarked that the logical operations shown may be implemented (1) as a sequence of computer executed steps running on a computing system and/or (2) as interconnected machine modules within the computing system. The implementation is a matter of choice dependent on the performance requirements of the system implementing the invention. Accordingly, the logical operations making up the embodiments of the present invention described herein are referred to alternatively as operations, steps, or modules.

At assigning operation 502, a string identifier is assigned to an input string 504. As discussed above, the input string 504 includes text to be aggregated into documentation for an underlying application. The string identifier can be any unique label assigned to the input string 504. For example, the string identifier may include an automatically generated label containing a file name, sequence number and timestamp associated with the input string 504. After assigning operation 502 is completed, control passes to adding operation 506.

At adding operation 506, a granularity element 508 is added to the input string 504. The granularity element 508 specifies what document the input string 504 should be aggregated to. As mentioned above, the invention may utilize tag-based syntax to demarcate information within the input string 504. Various values may be assigned to the granularity element 508, such as operational manual, API, and design document. After adding operation 506 is completed, control passes to adding operation 510.

At adding operation 510, a target element 512 is added to the input string 504. The target element 512 specifies who the input string 504 is targeted to. Various values may be assigned to the target element 512, such as administrator, developer, architect, and end-user. After adding operation 510 is completed, control passes to creating operation 514.

At creating operation 514, a document element for the input string 504 is created with the granularity and target information included. It is noted granularity and target information are only examples of information fields that may be included in the document element. In a particular embodiment of the invention, the document element may be encrypted to control information access under a policy defined as a set of rules that constrain groups of document requesters. Hierarchically arranged access keys may be used to protect against unauthorized disclosure of information contained in document elements. A further embodiment of the invention may use checksums for integrity checks to detect the unauthorized creation, alteration, or deletion of document elements.

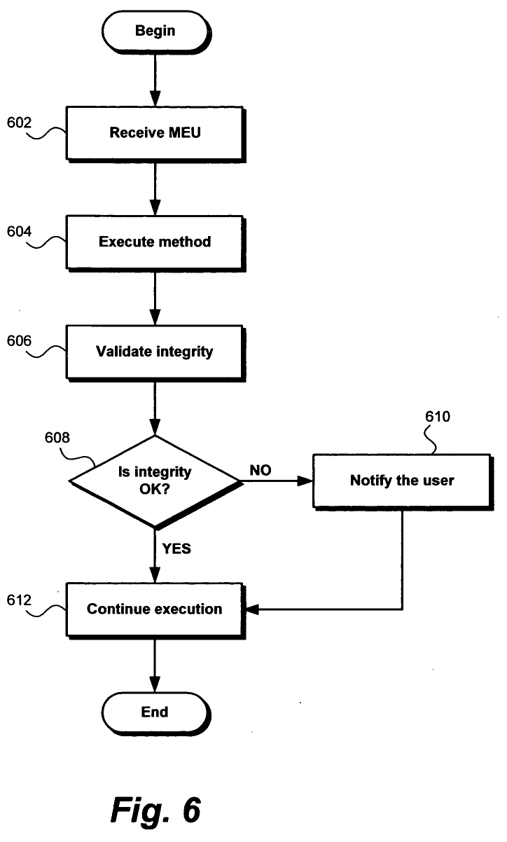

In FIG. 6, an exemplary process for validating the consistency of the document elements is shown. The process begins at receiving operation 602, where an MEU is received for validation. Next, at executing operation 604, an integrity check routine is performed on MEU and validating operation 606 compares the validation criteria to the document elements contained in the MEU. If, at decision operation 608, the MEU's integrity is validated, control passes from at decision operation 608 to continuing operation 612 where execution of the MEU continues. If, on the other hand, the MEU's integrity is not validated, control passes to notifying operation 610 and the user is alerted that the MEU has not passed the validation test. Control then continues to continuing operation 612 where execution of the MEU continues.

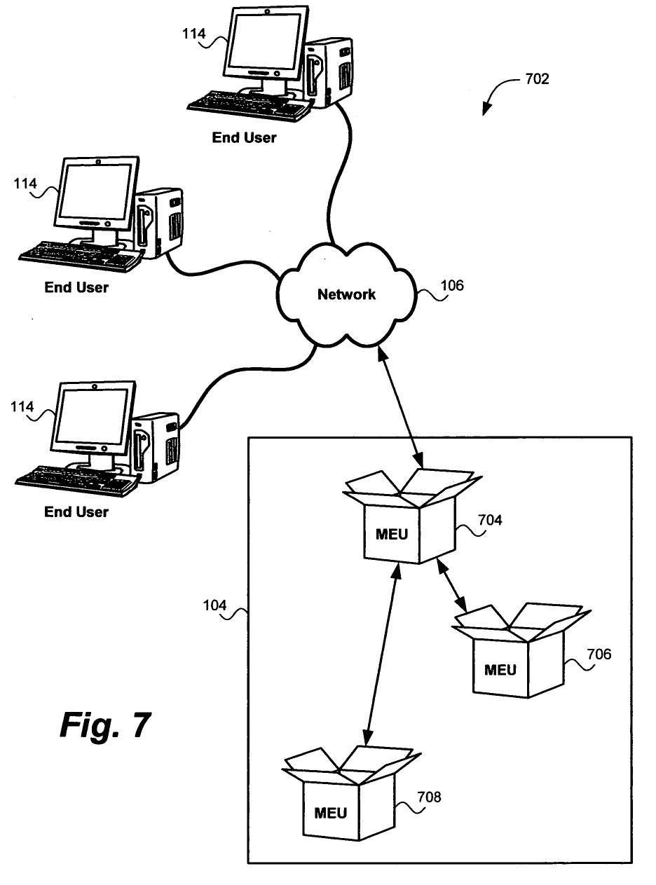

In FIG. 7, an exemplary execution environment 702 employing the present invention is shown. An end user 114, for example, requests document elements from a deployed MEU 704 on a server 104. Document elements from the MEU 704 are aggregated into a document and the document is delivered to the end user 114 in readable or printable form. The server 104 communicates with end users 114 over a network 106 such as the global Internet.

It is contemplated that the MEU 704 may request some document elements from other MEUs 706 and 708, and incorporates these document elements into the final document delivered to the end user 114. For example, complex business, financial, or scientific programs whose software involves multiple granular applications are really little more than amalgamations of other applications that invoke one another for various functions. The complexity of these granular applications should be accompanied by a flexible way of integrating appropriate document element. An embodiment of this invention can implement a “chain” document assembly where an application, while creating its own document elements, requests the document elements of another application it calls and incorporates them into its own document element.

The foregoing description of the invention has been presented for purposes of illustration and description. It is not intended to be exhaustive or to limit the invention to the precise form disclosed, and other modifications and variations may be possible in light of the above teachings. For example, an embodiment of the present invention may include several ready-made functions to reformat documents into HTML/XML or other output formats, such as Portable Document Format (PDF) or Rich Text Format (RTF). The embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for creating a minimum executable unit, the method comprising:
receiving at least one block of source code;
receiving at least one document element associated with the source code;
validating consistency between the source code and the document element; and
building an executable unit, the executable unit being responsive to both the source code and the document element.

2. The method of claim 1, further comprising receiving at least one external document for inclusion in the executable unit.

3. The method of claim 1, wherein the document element includes tag-based syntax to demarcate information.

4. The method of claim 1, further comprising demarcating a target audience of the document element.

5. The method of claim 1, further comprising providing a text editor configured to create the document element with tag-based syntax to demarcate information.

6. The method of claim 1, further comprising extracting the document element from the executable unit in such a way as to be readable as documentation.

7. The method of claim 1, further comprising aggregating the document element with other document elements.

8. The method of claim 7, wherein the other document elements are extracted from other executable units.

9. The method of claim 1, further comprising encrypting the document element.

10. Program code embodied on computer-readable media, the program code comprising:
at least one block of source code providing executable computer instructions; and
at least one documentation string coupled to the source code, the documentation string including:
a method indicia configured to identify the method where the documentation string is located;
a target indicia configured to identify who the documentation string is targeted to; and
a granularity indicia configured to identify the what document documentation string should be a part of.

11. The program code of claim 10, wherein the documentation string further includes an identification indicia, a timestamp, and a sequence number.

12. The program code of claim 10, wherein the documentation string further includes tag-based syntax to demarcate information.

13. The program code of claim 10, wherein the documentation string is encrypted.

14. A system for creating a minimum executable unit, the system comprising:
at least one block of source code;
at least one document element associated with the source code;
a validation criteria configured to validate the consistency between the source code and the document element; and
builder configured to construct an executable unit, the executable unit being responsive to both the source code and the document element.

15. The system of claim 14, further comprising an import module coupled to the builder and configured to receive document elements from external document providers.

16. The system of claim 14, further comprising a repository access module coupled to the builder and configured to store and retrieve document elements in at least one database.

17. A computer program product embodied in a tangible media comprising:
computer readable program codes coupled to the tangible media for creating a minimum executable unit, the computer readable program codes configured to cause the program to:
receive at least one block of source code;
receive at least one document element associated with the source code;
validate consistency between the source code and the document element; and
build an executable unit, the executable unit configured to be responsive to both the source code and the document element.

18. The computer program product of claim 17, further comprising program code configured to receive at least one external document for inclusion in the executable unit.

19. The computer program product of claim 17, wherein the document element includes tag-based syntax to demarcate information.

20. The computer program product of claim 17, further comprising program code configured to demarcate a target audience of the document element.

21. The computer program product of claim 17, further comprising program code configured to provide a text editor configured to create the document element with tag-based syntax to demarcate information.

22. The computer program product of claim 17, further comprising program code configured to extract the document element from the executable unit in such a way as to be readable as documentation.

23. The computer program product of claim 17, further comprising program code configured to aggregate the document element with other document elements.

24. The computer program product of claim 17, wherein the other document elements are extracted from other executable units.

25. The computer program product of claim 17, further comprising program code configured to encrypting the document element.
